(19) United States
(12) Patent Application Publication
(10) Pub. No.: US 2025/0344104 A1
(43) Pub. Date: Nov. 6, 2025

(54) METHOD FOR RESOURCES UTILIZATION OF NETWORK SLICES

(71) Applicant: Google LLC, Mountain View, CA (US)

(72) Inventor: Mohamed Negm, Hamburg (DE)

(21) Appl. No.: 18/866,455

(22) PCT Filed: May 19, 2023
(86) PCT No.: PCT/US2023/023022

§ 371 Date: Nov. 15, 2024

Related U.S. Application Data
(60) Provisional application No. 63/344,499, filed on May 20, 2022.

(51) Int. Cl. H04W 28/16; H04W 52/02

(52) U.S. Cl. CPC H04W 28/16; H04W 52/0203

(57) ABSTRACT

This disclosure provides systems, devices, apparatuses, and methods, including computer programs encoded on storage media, for introducing a hibernation state. The method includes receiving a first trigger on a network slice to transition the network slice from an operation state to a hibernation state. The hibernation state includes a full hibernation state and a partial hibernation state. The method includes releasing a first subset of a network resource associated with the network slice while maintaining a second subset of network resources associated with the network slice. The method includes transitioning a state of the network slice to be in the partial hibernation state based on the state of at least one slice subnet. The at least one slice subnet is in a hibernation state while one or more other slice subnets remain active.

### CROSS-REFERENCE TO RELATED APPLICATIONS

This application claims the benefit of and priority to U.S. Provisional Patent Application No. 63/344,499 filed on May 20, 2022, the entirety of which is incorporated by reference herein.

### TECHNICAL FIELD

The present disclosure relates generally to wireless communication, and more particularly, to systems and methods of resources utilization of network slices

### BACKGROUND

Network Slicing offers the capability to segment and isolate radio access network (RAN) and core network (CN) resources in an automated manner. As Network Slices as a Services (NSaaS) emerges in importance, NSaaS places extra burdens on the network operators to extend their network capabilities and resources. There is an opportunity to reduce these extra burdens and provide NSaaS with fewer and flexible network resource deployments.

### SUMMARY

The following presents a simplified summary of some aspects in order to provide a basic understanding of such aspects. This summary is not an extensive overview of all contemplated aspects. Its sole purpose is to present some concepts of one or more aspects in a simplified form as a prelude to the more detailed description discussed below.

Currently, a new network slice is triggered through slice profiles (e.g., the network requirements, quality of service (QOS) requirements) and service profiles (e.g., the service requirements), and the network slice is created. After slice creation, the resources of the network slice (RAN, CN, and transport network) are reserved to fulfill the service profile. The combined profiles traverse the network slice life-cycle management states which are: preparation, commissioning, operation, and decommissioning. With the dynamic nature of a mobile network, a service consumer of a network slide might not always be online or using the service continuously in all geographic locations assigned by a network operator for that network slice. Thus, the assigned RAN resources reserved for the network slice may go unused. As a result, the operational efficiency of the network operator might be reduced. Further, network slice customers may incur extra costs, and other services may be blocked from using these underutilized resources.

Aspects of the present disclosure address the above-noted and other deficiencies by introducing an additional state within the life-cycle of a network slice: hibernation. As an example, this state may be defined by certain attributes included in a hibernation policy in the network slice profile. The hibernation state modifies the network slice during the operation state in order to release underutilized resources. Different slice subnets within the network slice go into hibernation if certain attributes are met according to the hibernation policy in the network slice profile. Transitioning from the operation state to the hibernation state releases some network slice resources for other network slice(s) to use. As an example, a core network stores information related to the released network slice resources in a state database. The core network assigns the original service associated with the network slice with a higher priority and tags the new service associated with other network slice(s) with a lower priority. For example, a network slice selection function (NSSF) of the CN stores and assigns the priority of the service. The NSSF might determine the priority based on configurations and offering by the slice provider, such as (but not limited to): service type offered (e.g., broadband, emergency service, voice), customer subscription level/priority, location of service offered, etc. Therefore, when the original service requests the resources, the core network releases the resources from the new, lower priority service and assigns the released resources back to the original service. The core network then transitions the network slice back to the operation state.

The hibernation state includes a full hibernation state and a partial hibernation state. In the full hibernation state, the network slice resources are fully in hibernation across all the slice subnets (CN, RAN, and transmission) to release underutilized resources. In the partial hibernation state, only a set of resources are in hibernation (e.g. radio resources in certain regions only, specific transmission links) while other resources of the network slice remain assigned to the original service. After any of the hibernated resources are requested by the original service associated with the network slice, if all resources are active, then the core network changes the state of the network slice to the operation state. Otherwise, if a portion of the resources is still in hibernation, then the core network changes the state of the network slice to the partial hibernation state. The core network restores the resources based on the priority that is stored in the state database.

In some aspects, the present disclosure discloses a method performed by a core network. The method includes the CN receiving a first trigger on a network slice to transition the network slice from an operation state to a hibernation state. The network slice includes a plurality of slice subnets including a core slice subnet and a radio access network (RAN) slice subnet. The method includes the CN releasing a network resource associated with the network slice in response to receiving the first trigger. The method includes the CN updating a state of at least one slice subnet of the plurality of slice subnet to be in a hibernation state in response to releasing the network resource. The method includes the CN transitioning a state of the network slice to be in the hibernation state based on the state of the at least one slice subnet of the plurality of slice subnet.

In some aspects, the present disclosure discloses a core network. The core network includes one or more radio frequency (RF) modems, a processor coupled to the one or more RF modems, and at least one memory storing executable instructions, the executable instructions to manipulate at least one of the processor or the one or more RF modems to perform the method discussed above.

In some aspects, the present disclosure discloses a method performed by a base station. The method includes the base station receiving a first trigger on a network slice to transition the network slice from an operation state to a hibernation state. The network slice includes a plurality of slice subnets including a core slice subnet and a RAN slice subnet. The method includes the base station sending a first message to a CN to indicate a usage of resources associated with the network slice satisfying a first predetermined usage threshold. In response to the message being sent, the CN releases a network resource associated with the network slice, the CN updates a state of the RAN slice subnet to be in a hibernation state, and where the CN transitions a state of the network slice to be in the hibernation state based on the state of the RAN slice subnet.

In some aspects, the present disclosure discloses a base station. The base station includes one or more radio frequency (RF) modems, a processor coupled to the one or more RF modems; and at least one memory storing executable instructions, the executable instructions to manipulate at least one of the processor or the one or more RF modems to perform the method discussed above.

Advantageously, according to embodiments of the present disclosure, the valuable RAN resources are being allocated efficiently to meet the increasing services demands and requirements. The operational efficiency of the network operator is improved for non-slice or lower-priority network slicing services. Moreover, other services are able to run smoothly by using the resources that would otherwise be reserved for the original service and temporarily unused.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an environment for implementing network slicing, according to some embodiments.

FIG. 2 is a diagram illustrating a wireless communications system and an access network, according to some embodiments.

FIG. 3 is a state diagram illustrating a hibernation state within a life-cycle of a network slice, according to some embodiments.

FIGS. 4A-4C are signaling diagrams illustrating a process of updating restoration of a state of a CN slice subnet, according to some embodiments.

FIGS. 4D-4F are signaling diagrams illustrating a process of restoration of a state of a CN slice subnet of a network slice, according to some embodiments.

FIGS. 5A-5C are signaling diagrams illustrating a process of updating of a state of a RAN slice subnet, according to some embodiments.

FIGS. 5D-5E are signaling diagrams illustrating a process of restoration of a state of a RAN slice subnet, according to some embodiments.

FIG. 6 is a flow diagram illustrating a method of a CN introducing a hibernation state within a life-cycle of a network slice, according to some embodiments.

FIG. 7 is a flow diagram illustrating a method of a base station introducing a hibernation state within a life-cycle of a network slice, according to some embodiments.

### DETAILED DESCRIPTION

The detailed description set forth below is intended as a description of various configurations and is not intended to represent the only configurations in which the concepts described herein may be practiced. The present disclosure provides several aspects of communication systems with reference to various apparatus and methods. The present disclosure describes these apparatus and methods in the following detailed description.

For ease of illustration, the following techniques are described in an example context in which one or more UE devices and RANs implement one or more radio access technologies (RATs) such as a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UE devices and the RANs. Also, the present disclosure is not limited to the cellular wireless examples and context described herein, but rather the techniques described herein can be applied to any network environment implementing network slicing.

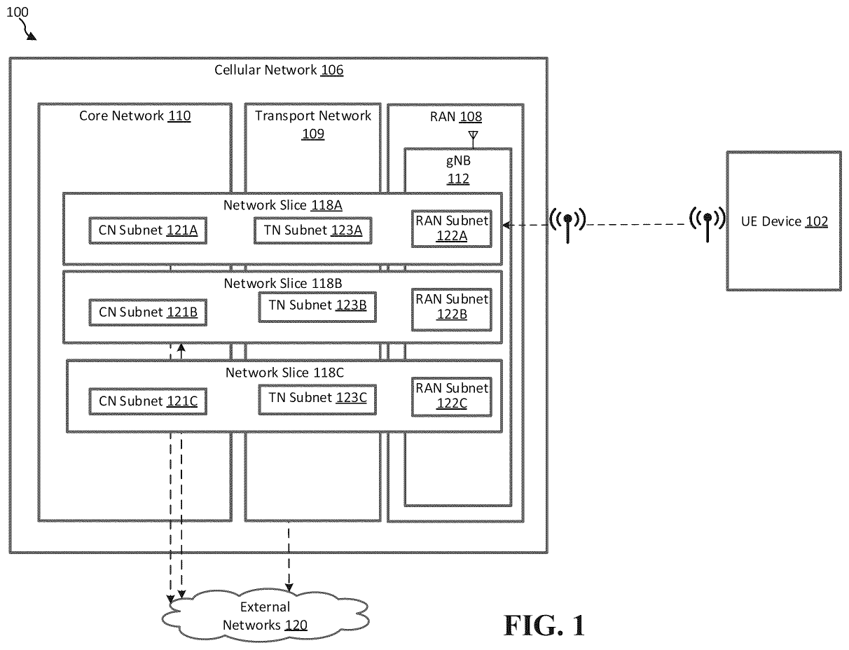

FIG. 1 is a block diagram illustrating an example environment 100 for implementing network slicing, according to some embodiments. The environment 100 includes a cellular network 106 and a UE device 102 (sometimes referred to as, “host UE device 102”). The present disclosure is not limited to a cellular network, and the techniques described herein apply to other types of wireless communication systems. The cellular network 106 includes a radio access network (RAN) 108, a core network 110 and a transport network (TN) 109. The environment 100 includes an external network 120, such as the Internet or a public switched telephone network (PSTN), that is coupled to the cellular network 106 via the core network 110. The cellular network 106 may include additional components not shown in FIG. 1.

The UE devices 102 may represent any of a variety of electronic devices capable of wired and/or wireless communications, such as a smartphone, a tablet computer, a notebook computer, a desktop computer, a wearable device (e.g., smartwatch, headset, wireless earbuds, fitness tracker, blood pressure monitor, smart jewelry, smart clothing, smart glasses, etc.), an automobile or other vehicle employing wireless communication services (e.g., for navigation, provision of entertainment services, in-vehicle mobile hotspots, etc.), a gaming device, a media device, an Internet of Things (IoT) device (e.g., sensor node, controller/actuator node, or a combination thereof), and another device capable of wired and/or wireless communication.

The RAN 108 is accessible using, for example, a 5G NR RAT and is to at least the core network 110. A RAN 108 implementing a 5G NR RAT may be referred to as a 5G NR RAN or an NR RAN. One example of a core network 110 in a 5G cellular network is a Fifth-Generation Core (5GC) network.

Each RAN 108 includes one or more base stations 112 (shown in FIG. 1 as “gNB”) operable to wirelessly communicate with the UE devices 102 within signal range. A base station 112 may be implemented as an integrated gNB base station or as a distributed base station with a central unit (CU) and one or more distributed units (DU) and optionally one or more remote units (RUS). Irrespective of base station architecture, each base station 112 supports at least one “cell” of coverage for the RAN 108. A base station 112 defines a macrocell, microcell, small cell, picocell, or the like, or any combination thereof. Consistent with the terminology employed by the 5G NR standard, a base station implementing a 5G NR RAT is referred to herein as “5G NodeB” or “gNB”. The base station operates as an “air interface” to establish radio frequency (RF) wireless communication links (e.g., an upstream link or uplink toward a CN, a downstream link or downlink toward a UE) with UE devices 102, which can be implemented as any suitable type of wireless communication link. These wireless communication links then serve as data paths (including control information) between the UE devices 102 and the core network 110, which is coupled to the one or more of the external networks 120, for providing various services to the UE devices 102. Examples of these services include voice or data services via packet-switched networks, messaging services such as simple messaging service (SMS) or multimedia messaging service (MMS), audio, video, or multimedia content delivery, presence services, and so on. Multiple wireless communication links from multiple base stations 112 can be configured for Coordinated Multipoint (COMP) communication with the UE devices 102. A base station can aggregate multiple wireless communication links in a carrier aggregation to provide a higher data rate for the UE devices 102. The base station can configure multiple wireless communication links for single-RAT or multi-RAT dual connectivity (MR-DC).

The core network 110 establishes one or more network slices 118 of the cellular network 106, e.g., network slice 118A, network slice 118B, and network slice 118-C. Each network slice 118 provides isolation of RAN and core resources of the cellular network 106 to support guaranteed service levels for devices and services. As such, each network slice 118 is separate from the other network slices 118 of the cellular network 106. A network slice 118 communicatively couples the UE device 102 to the cellular network 106 over one or more wireless communication links to allow the UE device 102 to access the RAN and core resources of the network slice 118 over its corresponding links. As used herein, a wireless communication link (or simply, “link”) may correspond to a set of wireless communication links, such as one or more of an upstream data link, an upstream control link, a downstream data link, or a downstream control link. As shown in FIG. 1, a network slice 118 may be extended into external networks 120 to connect the UE devices 102 in the external network 120 to the cellular network 106.

FIG. 1 and the other figures may use like reference numerals to identify like elements. A letter after a reference numeral, such as “118A,” indicates that the text refers specifically to the element having that particular reference numeral. A reference numeral in the text without a following letter, such as “118,” refers to any or all of the elements in the figures bearing that reference numeral.

Examples of network slices 118 include network slices configured for 5G NR enhanced Mobile Broadband (eMBB), 5G Ultra-Reliable Low Latency Communications (URLLC), 5G NR massive Machine Type Communications (mMTC), massive Internet-of-Things (MIoT), and so on. The cellular network 106 may support any number and combination of network slices 118, including those not illustrated in FIG. 1.

Still referring to FIG. 1, the core network 110 receives a first trigger on the network slice 118 (e.g., 118A, 118B, or 118C) to transition the network slice 118 from an operation state to a hibernation state. The network slice 118 includes a plurality of slice subnets including a CN slice subnet 121 (e.g., 121A, 121B, or 121C), a TN slice subnet (e.g., 123A, 123B, or 123C), and a radio access network (RAN) slice subnet 122 (e.g., 122A, 122B, or 122C). The core network 110 releases one or more resources associated with the slice in response to receiving the first trigger. The core network 110 updates a state of at least one slice subnet of the plurality of slice subnet to be in a hibernation state in response to releasing the one or more resources. The core network 110 transitions a state of the slice 118 to be in the hibernation state based on the state of the at least one slice subnet of the plurality of slice subnet

The gNB 112 receives a first trigger on the network slice 118 to transition the network slice 118 from an operation state to a hibernation state. The gNB 112 sends a first message to the core network 110 to indicate a usage of resources associated with the RAN slice subnet 122 satisfying a first predetermined threshold. In response to the message being sent, the CN releases one or more resources associated with the network slice 118, where the CN updates a state of the RAN slice subnet 122 to be in a hibernation state, and the CN transitions a state of the network slice 118 to be in the hibernation state.

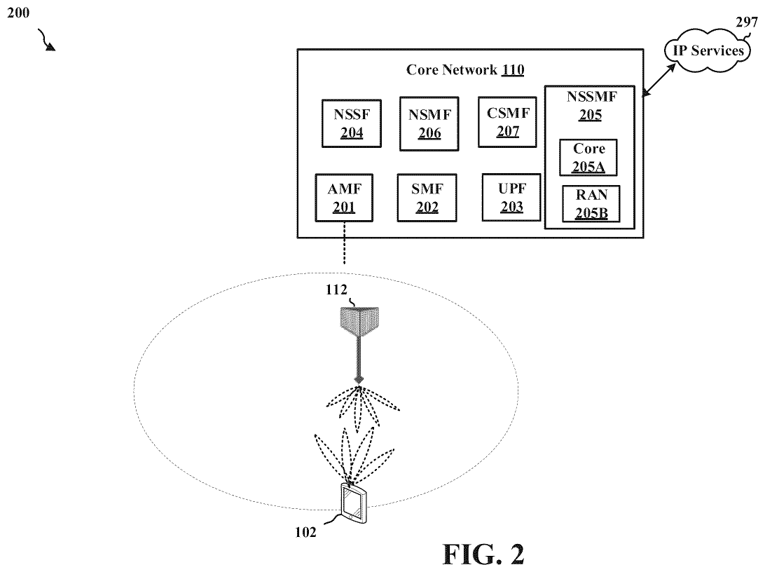

FIG. 2 is a diagram illustrating an example of a wireless communications system and an access network 200, according to some embodiments. The wireless communications system (also referred to as a wireless wide area network (WWAN)) includes a base stations 112, a UE device 102, and a core network 110 (e.g., a 5G Core (5GC)). The base stations 112 may include macrocells (high power cellular base station) and/or small cells (low power cellular base station). The macrocells include base stations. The small cells include femtocells, picocells, and microcells.

The base stations 112 configured for 5G NR may interface with core network 110 through backhaul links (not shown). In addition to other functions, the base stations 112 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages.

The base stations 112 may wirelessly communicate with the UE device 102. The base station 112 may provide communication coverage for a respective geographic coverage. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication link between the base station 112 and the UE device 102 may include uplink (UL) (also referred to as reverse link) transmissions from the UE device 102 to the base station 112 and/or downlink (DL) (also referred to as forward link) transmissions from the base station 112 to the UE device 102. The communication link may use multiple-input and multiple-output (MIMO) antenna technology, including spatial multiplexing, beamforming, and/or transmit diversity.

Referring again to FIG. 2, the core network 110 includes an Access and Mobility Management Function (AMF) 201, a Session Management Function (SMF) 202, and a User Plane Function (UPF) 203. The AMF 201 is the control node that processes the signaling between the UE device 102 and the core network 110. Generally, the AMF 201 provides QoS flow and session management. The SMF 202 interacts with the AMF 201 to establish, modify, and release PDU sessions. All user Internet protocol (IP) packets are transferred through the UPF 203. The UPF 203 provides UE IP address allocation as well as other functions. The UPF 203 is connected to the IP Services 297. The IP Services 297 may include the Internet, an intranet, an IP Multimedia Subsystem (IMS), a PS Streaming Service, and/or other IP services.

The core network 110 may further include a network slice selection function (NSSF) 204, a network slice subnet management function (NSSMF) 205, a network slice management function (NSMF) 206, and a Communication Service Management Function (CSMF) 207. For example, the NSSF 204 selects the network slice available for the service requested by the user in the 5G environment where various services are provided. The NSSMF 205 is responsible for the management and orchestration of the network slice subnet Instance throughout its lifecycle. The NSSMF 205 might include Core NSSMF 205A and RAN NSSMF 205B as sub-functions. The NSMF 206 controls the slice, end to end, across the RAN, transport, and core slice subnets. The CSMF 207 acts as the user interface for slice management. The CSMF 207 might store the information related to the hibernation of the slice.

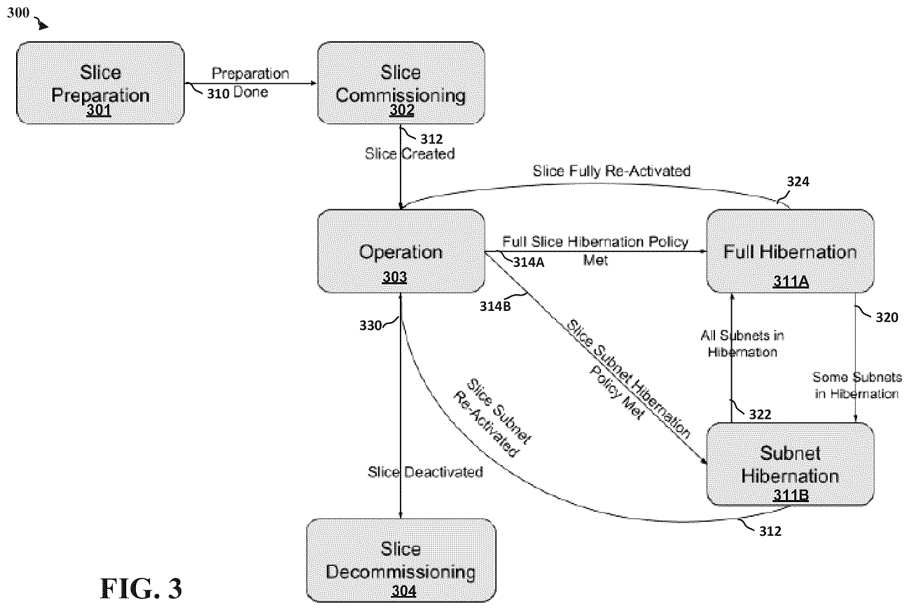

FIG. 3 is a state diagram 300 illustrating an example of a hibernation state 311 within a life-cycle of a network slice (e.g., network slice 118 in FIG. 1). Referring to FIG. 3, in order to address the problems that the service consumers might not always be online or using the service continuously in all coverage areas and to improve the operational efficiency of the network operator, the present disclosure introduces an additional hibernation state 311 within the life-cycle of the network slice in addition to a slice preparation state 301, a slice commissioning state 302, an operation state 303, and a slice decommissioning state 304.

The current approach to trigger the slice is through slice profiles (e.g., the network requirements, QoS requirements) and service profiles (e.g., the service requirements). Afterwards, the CN creates the slice. The service profile describes components with regarding to the service (e.g., eMBB, MIOT, URLLC, V2X, smart grid, Remote Healthcare, etc.) and the coverage area for the service, as well as other network slice-related requirements. The slice creation will take place afterwards, and the resources of the slice (RAN, CN, and TN) are reserved to fulfill the service profile. Both profiles are combined to go through the slice life-cycle management which starts at the slice preparation state 301. When the CN completes 310 the slice preparation, it enters the slice commissioning state 302. After the CN creates 312 the slice, the slice enters an operation state 303. When the CN deactivates the slice, the slice decommissioning state 304 occurs, as illustrated in FIG. 3.

In addition to the basic four states 301, 302, 303, 304 of a slice life-cycle, FIG. 3 shows a full hibernation state 311A and a subnet hibernation state 311B. Both hibernation states 311A, 311B may be generalized into a single hibernation state 311. As an example, the hibernation state 311 might be defined by certain attributes included in a hibernation policy in the slice profile. For example, the hibernation state 311 is a modification of the state of the slice during the operation state 303 in order to release resources. In some embodiments, rather than hibernating the full slice, some slice subnets within the slice go into hibernation if certain attributes are met according to the hibernation policy in the slice profile. The CN transitions the slice from the operation state 303 to the hibernation state 311 to release the resources for other slice(s).

The CN stores information related to the released resources in a state database, which correlates released resources with the service being hibernated with a higher priority, while tagging the new service associated with other slice(s) with a lower priority. Therefore, after the original service requests a return of the resources, the CN automatically releases the resources from the new service and assign the resources back to the original service. Then the CN transitions the slice back to the operation state 303.

This embodiment shows the hibernation state 311 including a full hibernation state 311A and a partial hibernation state 311B. In the full hibernation state 311A, the slice resources are fully in hibernation across all the slice subnets (CN, RAN, and TN). In the partial hibernation state 311B, only a portion of slice resources are in hibernation (e.g. radio resources in certain regions of the coverage areas, specific transmission links). As illustrated in FIG. 3, during the operation state 303 of the slice, when full slice hibernation policy being met 314A, the CN transitions the slice from the operation state 303 to the full hibernation state 311A; when slice subnet hibernation policy being met 314B, the CN transitions the slice from the operation state 303 to the partial hibernation state 311B. The CN transitions 322 the partial hibernation state 311B to the full hibernation state 311A when all slice subnets are in hibernation. The CN transitions 320 from the full hibernation state 311A to the partial hibernation state 311B when some of the slice subnets reactivate such that not all slice subnets are in hibernation. The CN allocates the slice subnet resources among services based on the priority stored in the state database.

After the original service associated with the slice requests all of the hibernated resources, the CN transitions 324 the full slice from the full hibernation state 311A to the operation state 303 if all resources had been released. And if the slice was in a subnet hibernation state 311B, the CN transitions 312 the state of the slice to the operation state 303. The CN restores the resources to the original service based on the priority stored in the state database.

Referring to FIGS. 1-3, the network slice 118 includes the CN slice subnet 121, the RAN slice subnet 122 and the TN slice subnet 123. After the CN activates the slice and the slice is in the operation state 303, the different slice subnets within the slice might go into hibernation, for example, if certain attributes are met as per the slice profile with hibernation policy. The attributes might address different slice subnets within the slice.

Regarding to the CN slice subnet 121, as an example, attributes relating to the network functions (NFs) serving the core network of the slice might include number of subscribers, power consumption, guaranteed latency, QoS provided for slice subscribers/consumers, etc. If these attributes are met, the policy defined within the profile might trigger the hibernation state of the core network slice subnet, which might instruct the slice to use less resources on the core network side (e.g., smaller size of NFs, reduce CPU cycles for these NFs, etc.)

Regarding to the RAN slice subnet 122, many attributes might be used here to trigger the hibernation state 311, such as the number of connected users, the amount of radio links utilized, current cell power consumption, etc. The policy can trigger the release of such resources in specific geographic locations, regions, or coverage areas to provide chances to other slices and services to be served within the hibernated area.

Regarding to the TN slice subnet 123, attributes used to trigger the hibernation state 311 might include latency, QoS, jitter, etc.

For example, a “meta” or composite cost function might trigger the hibernation state 311. The “meta” or composite cost function might depend on both a CN cost function and a RAN cost function. The CN might determine the CN cost function, the RAN cost function, and/or the “meta” or composite cost function based on a policy configuration, or based on resources consumption and trend analysis for each slice consumer.

The NSSF 204 includes information about each slice subnet being hibernated/restored. The information might further include priority related details, e.g., the priority of the service being hibernated. In the case of limited resources on the slice subnet being restored, the Core NSSMF 205 might use the information to better utilize the available resources. For example, the Core NSSMF 205 might share the available resources with other running services, or scale in the available resources, or delete other running services.

An overall state of the slice is maintaining the current state of the service and exposing the current state to the slice owner and network operator. The state might be defined for the whole slice and propagated to the charging systems as well to trigger different charging and costs towards the slice service customer. As an example, the state database might be part of the NSMF 206 used by the network operator and managing the slice within the network operator domain.

In each of the network slice subnet management functionality, the state of the slice subnet is maintained based on the used resources within this slice subnet. As an example, the NSSMF 205 might manage the state of the slice subnet using the Core NSSMF 205A and/or the RAN NSSMF 205B. The NSMF 206 decides the overall state of the slice based on the state of each of the slice subnets. After the NSSMF 205 updates the slice subnet to be in the hibernation state, a restoration procedure for each slice subnet might impact the overall state of the slice, based on how many slice subnets are still active/hibernated. If all slice subnets of the slice are active, the CN transitions the full slice state to be in the operation state 303; if all slice subnets are hibernated, the CN transitions the full slice to be in the full hibernation state 311A; if there is a mix of active and hibernated slice subnets, the CN transitions the slice to be in the partially hibernated state 311B.

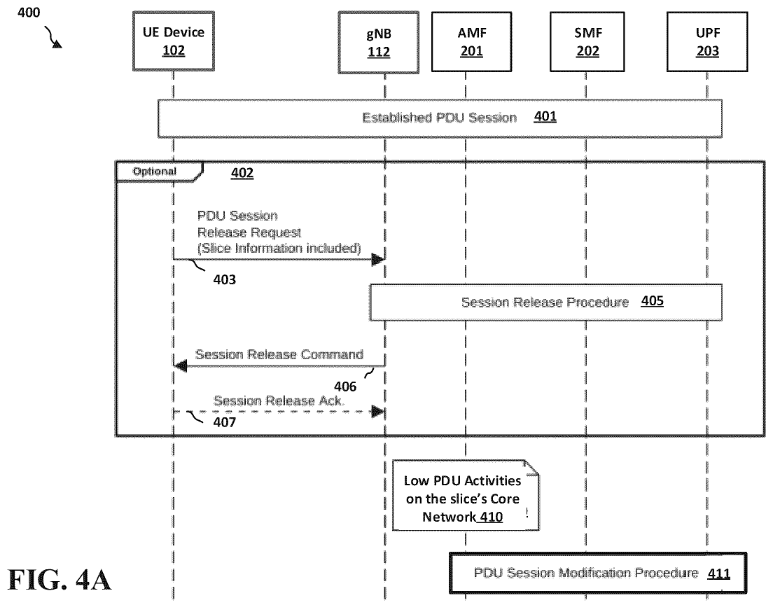

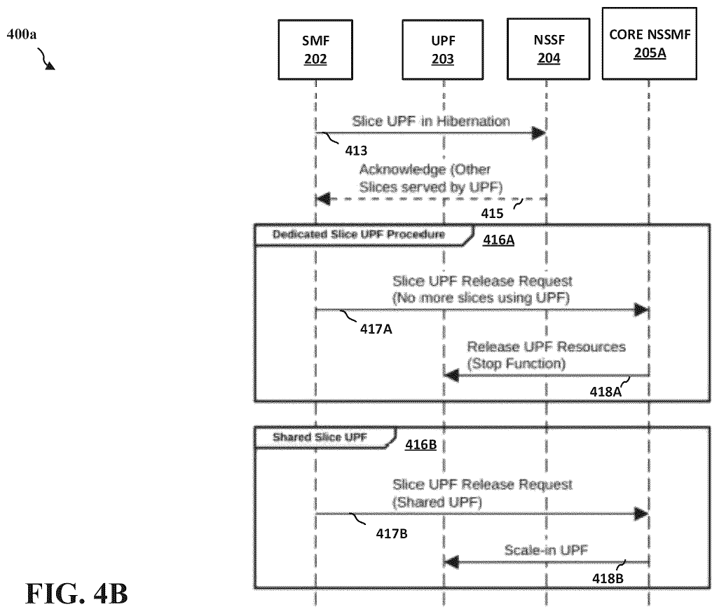

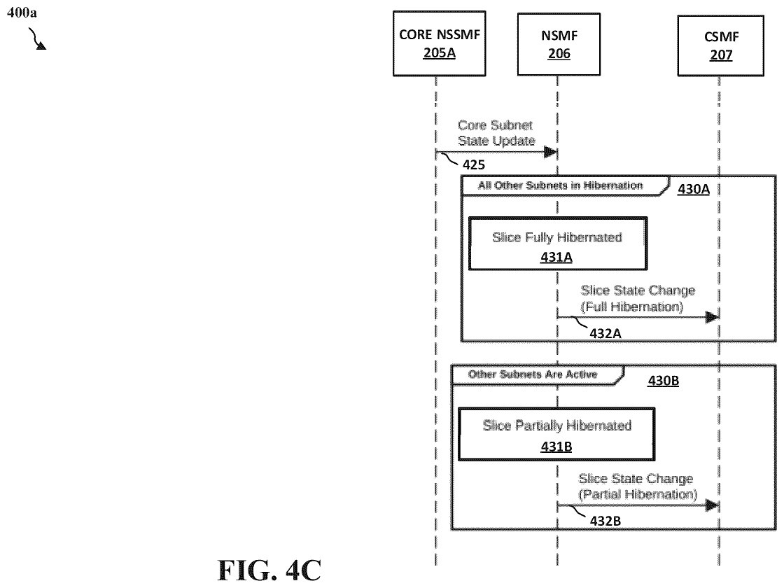

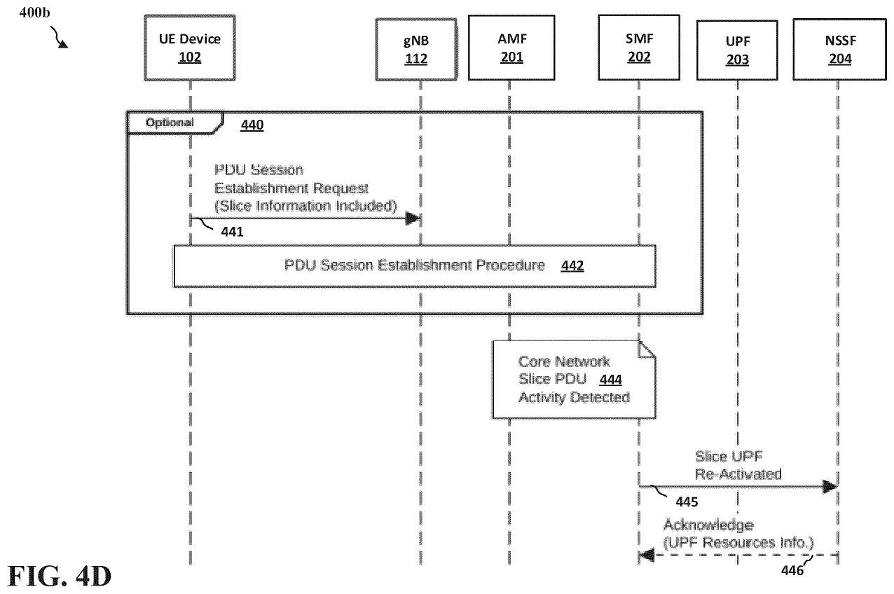

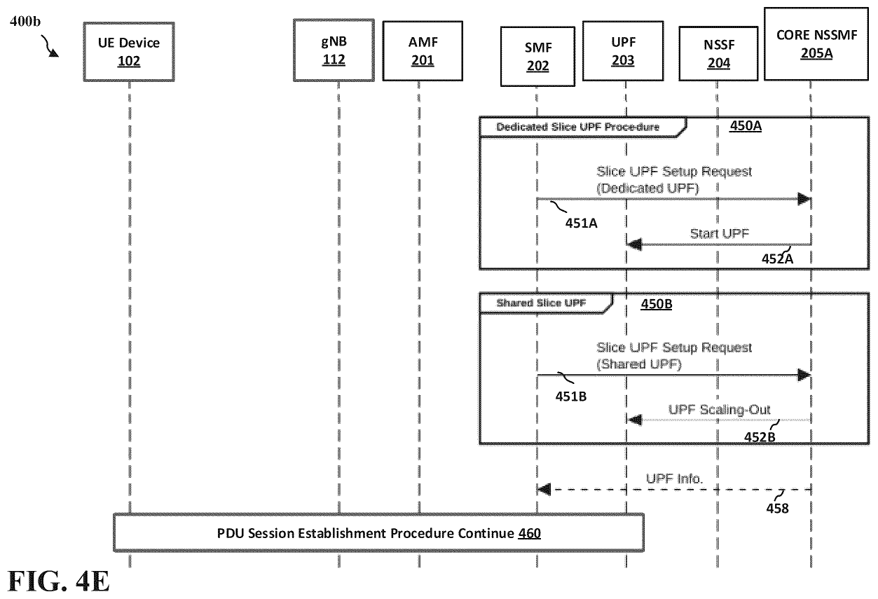

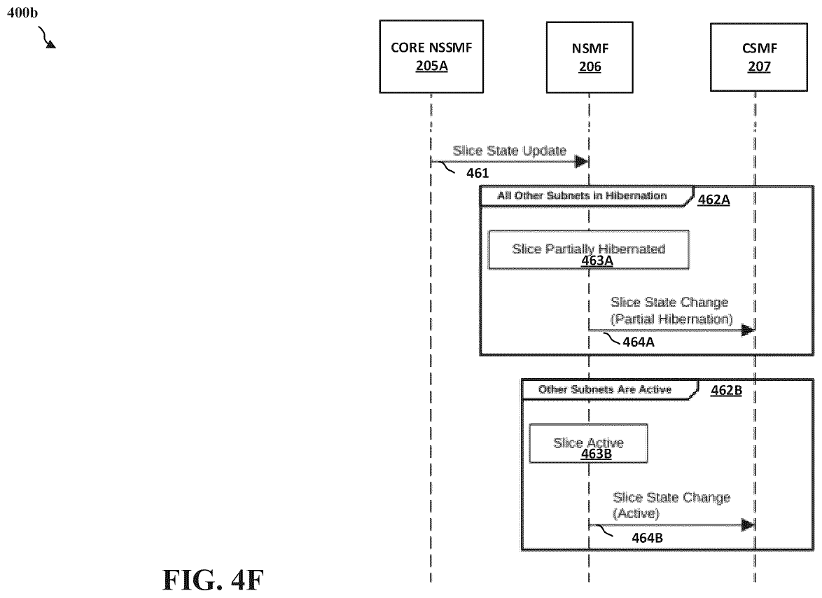

FIGS. 4A-4C are signaling diagrams illustrating a process 400a of updating and restoring a state of the CN slice subnet 121 of the network slice 118, according to some embodiments. It is appreciated that the blocks in process 400a might be performed in an order different than presented, that not all of the blocks in process 400a might be performed, and the blocks might be combined with other processes presented herein.

As illustrated overall in FIGS. 4A-4C, the CN receives a trigger to transition the network slice from an operation state 303 to a hibernation state (e.g., 311A or 311B), and the CN transitions the state of the network slice 118 to be in the hibernation state based on the state of the CN slice subnet 121. For example, the state change of the CN slice subnet 121 might be triggered via the SMF 202. Depending on whether the network slice undergoing hibernation has a dedicated UPF or a shared UPF, the SMF 202 and the Core NSSMF 205A perform a dedicated network slice UPF release procedure 416A or a shared network slice UPF release procedure 416B. After completion of the slice UPF hibernation procedure 416A or 416B, the Core NSSMF 205 updates the state of the CN slice subnet to be in a hibernation state. Then, the NSMF 206 and the CSMF 207 perform a state transition procedure 430A or 430B to transition the state of the network slice to the full hibernated state 311A or the partial hibernated state 311B.

Referring to FIGS. 4A-4C in detail, the UE device 102 establishes 401 a protocol data unit (PDU) session with a network slice through the UPF 203 of the CN 110. The network slice 118 (e.g., any of network slices 118A-C) includes a plurality of slice subnets including the CN slice subnet (e.g., CN slice subnet 121), a TN slice subnet (e.g., CN slice subnet 123), and a radio access network (RAN) slice subnet (e.g., RAN slice subnet 122).

The UE device 102, the base station 112, and the UPF 203 might perform a PDU session release procedure 402. This is an optional procedure 402. The UE device 102 might send a PDU session release request 403 to the base station 112. As an example, the UE device 102 might move to a different region or doesn't want to be connected any more. The base station 112 might send the PDU session release request to the UPF 203. The PDU session release procedure 405 might start. The base station 112 might send a session release command 406 to the UE102. The UE device 102 might send an acknowledgement of receipt 407 of the session release command to the base station 112.

The AMF 201 detects a first trigger 410 on the slice to transition the slice from an operation state 303 to a hibernation state 311. As an example, the AMF 201 detects the PDU session activities below a first predetermined threshold on the CN slice subnet. As an example, the AMF 201 receives a message from the base station 102 (e.g., as part of 405) indicating the PDU session activities below a first predetermined threshold on the CN slice subnet. The AMF 201 starts a PDU session modification procedure 411 with the UPF 203 based on the first trigger 410.

Continuing to FIG. 4B, the SMF 202 sends a message 413, to the NSSF 204, requesting to release at least a portion of resources of a UPF associated with the CN slice subnet. As an example, after the SMF 202 detects that no more PDU sessions are using the UPF, the SMF might notify both the NSSF 204 and NSSMF 205. The SMF 202 might send the message 413 to the NSSF 204, asking to put the UPF in hibernation so that the resources assigned to the UPF might be released.

The NSSF 204 sends a message 415 to the SMF 202, to acknowledge the request of the SMF with information and indicate whether the UPF associated with the CN slice subnet is a dedicated slice UPF or a shared slice UPF. The NSSF 204 might store the priority of the service associated with the slice. The NSSF 204 might determine a priority for a service associated with the slice, and storing information related to the one or more resources in a state database, where the information includes the priority for the service associated with the slice. The core network assigns the original service associated with the network slice with a higher priority and tags the new service associated with other network slice(s) with a lower priority. For example, the NSSF 204 might determine the priority based on configurations and offering by the slice provider, such as (but not limited to): service type offered (e.g., broadband, emergency service, voice), customer subscription level/priority, location of service offered, etc. The NSSF 204 might store the UPF status with respect to the slice in order to be able to prioritize the restoration in case of limited resources. The NSSF 204 might acknowledge the request 413 of the SMF with information related to the other usages of the UPF (dedicated or shared). In the message 415, the NSSF 204 might include information about each slice subnet being hibernated, which the NSSF 204 will later use when restoring slice subnets. The information might also include priority related details. The NSSF 204 might store the UPF status with respect to the slice in order to be able to prioritize the restoration in case of limited resources.

When the network slice undergoing hibernation has a dedicated UPF, the SMF 202 and the Core NSSMF 205A perform a dedicated network slice UPF release procedure 416A. As part of this procedure 416A, the SMF 202 sends a message 417A to the Core NSSMF 205A of the core network, to request releasing all the resources of the UPF associated with the CN slice subnet when the UPF associated with the CN slice subnet is the dedicated slice UPF. The Core NSSMF 205A releases 418A all of the resources of the UPF associated with the CN slice subnet when the UPF associated with the CN slice subnet is the dedicated slice UPF.

When the network slice undergoing hibernation has a shared UPF, the SMF 202 and the Core NSSMF 205A perform a shared network slice UPF release procedure 416B. As part of this procedure 416B, the SMF 202 sends a message 417B to the Core NSSMF 205A of the core network, to request releasing a portion of the resources of the UPF associated with the CN slice subnet when the UPF associated with the CN slice subnet is the shared slice UPF. The Core NSSMF 205A releases 418B a portion of the resources of the UPF associated with the CN slice subnet when the UPF associated with the CN slice subnet is the shared slice UPF.

The NSSMF 205 might trigger a scale-in procedure for the UPF or completely stop and release the resources (whether a shared or dedicated UPF is being used). Two possible cases arise in this scenario, either the UPF is fully dedicated to a specific slice, or the UPF is a shared UPF and used by multiple slices. With respect to the dedicated slice UPF procedure 416A, after a UPF is not currently serving any traffic of the slice (users are connected through another UPF, or not active PDU sessions for users), the SMF 202 might trigger the hibernation of the UPF resources, where the NSSMF 205 might stop the UPF and release the resources associated with the UPF. With respect to the shared slice UPF procedure 416B, the hibernation might be triggered using the same procedure as above, however, the UPF might not be stopped, the UPF might be scaled 418B to reduce resource usage while still allowing for regaining resources (sometimes called “scaling-in”), and/or allowing for other services to use the idle shared slice UPF resources.

Moving to FIG. 4C, after completion of the slice UPF hibernation procedure 416A or 416B, the Core NSSMF 205 updates the state of the CN slice subnet to be in a hibernation state and sends a message 425 to the NSMF 206 to indicate the updating of the state of the CN slice subnet.

Based on the message 425, the NSMF 206 and the CSMF 207 perform a state transition procedure 430A or 430B to transition the state of the network slice to the full hibernated state 311A or the partial hibernated state 311B, depending on whether the full slice hibernation policy is met 314A or the slice subnet hibernation policy is met 314B. For example, if all other slice subnets of the slice are in the hibernation state, the NSMF 206 transitions 431A a state of the slice to be in the full hibernation state based on that the state of the CN slice subnet (and each of all other slice subnets of the slice is in the hibernation state). The NSMF 206 might send a message 432A to the CSMF 207 to indicate the state of the slice being in the full hibernation state based on the state of the CN slice subnet (and each of all other slice subnets of the slice is in the hibernation state). The CSMF 207 might store the information related to the hibernation of the slice.

For another example, if other slice subnets (TN, RAN) of the slice remain active while the CN slice subnet hibernates, the NSMF 206 transitions 431B a state of the slice to be in the partial hibernation state based on the state of the CN slice subnet (and the other slice subnets of the slice are active). The NSMF 206 might send a message 432B to the CSMF 207 to indicate the state of the slice being in the partial hibernation state based on the state of the CN slice subnet (and one or more other slice subnets of the slice are active). The CSMF 207 might store the information related to the hibernation of the slice.

By this way, the slice is now in the fully hibernated state 311A or the partially hibernated state 311B, and the NSSF 204 has transitioned the slice from the operation state 303 to the hibernation state 311A/311B based on the state change of the CN slice subnet 121.

FIGS. 4D-4F are signaling diagrams illustrating a process 400b of restoration of the state of the CN slice subnet 121 of the network slice 118, according to some embodiments. It is appreciated that the blocks in process 400b might be performed in an order different than presented, that not all of the blocks in process 400b might be performed, and the blocks might be combined with other processes presented herein.

As illustrated in FIGS. 4D-4F, based on UE device 102 activity, the CN might receive a second trigger, e.g., detecting uplink or downlink PDU session activities above a second predetermined threshold on the CN slice subnet of the slice. The CN might restore at least a portion of the network resources in response to the second trigger based on the priority for the service associated with the network slice. The CN might transition the state of the network slice to be in the operation state 303 or the partial hibernation state 311B. The details of restoring the hibernated slice back to the operation state 303 or the partial hibernation state 311B will be discussed below.

The UE device 102, the gNB 112, the AMF 201 and the SMF 202 might perform an optional PDU session establishment procedure 440. The UE device 102 might come back to the coverage area and start reconnect. The UE device 102 might send a PDU session establishment request 441 including the slice information to the gNB 112. The PDU session establishment procedure 442 including the UE device 102, the base station 12, the AMF 201 and the SMF 202 might start. Although uplink data transfer is shown in FIG. 4D, downlink data transfer may also trigger PDU session establishment.

At least one of the AMF 201 or the SMF 202 might receive the second trigger. For example, at least one of the AMF 201 or the SMF 202 might detect 444 uplink or downlink PDU session activities above a second predetermined threshold on the CN slice subnet of the slice.

The SMF 202 requests 445 the NSSF 204 re-activate the UPF resources associated with the slice. As an example, the SMF 202 might query the NSSF 204 to get the resources allocation information of the UPF 203 based on the priority defined. The NSSF 204 sends an acknowledgement 446 to the SMF 202 with information about the UPF resources associated with the slice. The SMF 202 and the Core NSSMF 205A perform a network slice UPF setup procedure 450A for a dedicated slice UPF. The SMF 202 might request 451A the Core NSSMF 205A of the core network, to start the resources of the UPF associated with the CN slice subnet. The Core NSSMF 205A might make use of the resources priority information to better align and deploy the service in case of the dedicated UPF. The Core NSSMF 205A might start 452A all of the resources of the UPF associated with the CN slice subnet when the UPF associated with the CN slice subnet is the dedicated slice UPF.

For a shared slice UPF, the SMF 202 and the Core NSSMF 205A perform a network slice UPF setup procedure 450B. As part of this procedure 450B, the SMF 202 requests 451B the Core NSSMF 205A of the core network, to start a portion of the resources of the UPF associated with the CN slice subnet. The Core NSSMF 205A might start a portion of or scale out the resources of the UPF associated with the CN slice subnet when the UPF associated with the CN slice subnet is the shared slice UPF. The NSSMF 205A might scale out 452B currently running UPF 203 in case of the shared UPF.

The restoration of the hibernated slice resources might be performed based on the priority defined within the NSSF 204 when the hibernation was recorded by the SMF 202. After the UE device 102 initiates the request 441 to establish 442 the PDU session using the slice, the SMF 202 might query 445 the NSSF 204 for the network resources allocation information of the UPF 203 based on the priority defined. The CN might allocate the network resources to the network slice with a higher priority. In case of fully utilized UPF 203 (dedicated or shared) accompanied with lower priority slice resources, the NSSMF 205 might fail to assign the resources required to bring the slice subnet back from hibernation to the operation state 303. In this case, the NSSMF 205 will send (not shown) a rejection message to the SMF 202 with the reason “No Resources Available”. The SMF 202 might in turn generate a retry timer to avoid signaling storms and endless re-activation loops using one of the following options: randomly generated, predicted usage increase for the slice (relying on NWDAF for trend analysis), or slice restoration requests within a specific time frame. The information might propagate to the NSSMF 205 via the SMF 202. The NSSMF 205 might make use of the resources priority information to better align and deploy the service in case of the dedicated UPF 450A, or scale currently running UPF 203 in case of the shared UPF 450B.

The Core NSSMF 205A sends 458 the information about the resources of the UPF associated with the CN slice subnet to the SMF 202. For example, the information might include the IP/hostname of the UPF to connect to for setting up the session. The PDU session establishment procedure continues 460 with the UE device 102, the base station 12, the AMF 201, and the SMF 202mightcontinue.

Moving to FIG. 4F, the Core NSSMF 205A updates 461 the state of the CN slice subnet to be in an active state and inform the NSMF 206 the updating of the state of the CN slice subnet. The NSMF 206 and the CSMF 207 perform the state transition procedure 462A to transition the state of the network slice. The NSMF 206 transitions 463A the state of the slice to be in the partial hibernation state based on the state of the CN slice subnet and other one or more slice subnets of the slice are in the hibernation state. The NSMF 206 might inform 464A the CSMF 207 the state of the slice being in the partial hibernation state based on the state of the CN slice subnet and other slice subnets of the slice are in the hibernation state. Similarly, the NSMF 206 and the CSMF 207 perform the state transition procedure 462B to transition the state of the network slice. The NSMF 206 transitions 463B the state of the slice to be in an active state or the operation state the based on the state of the CN slice subnet and all other slice subnets of the slice are active. The NSMF 206 informs 464B the CSMF 207 the state of the slice being in the active state or the operation state based on the state of the CN slice subnet and all other slice subnets of the slice are active. The CSMF 207 might store the information related to the hibernation of the slice.

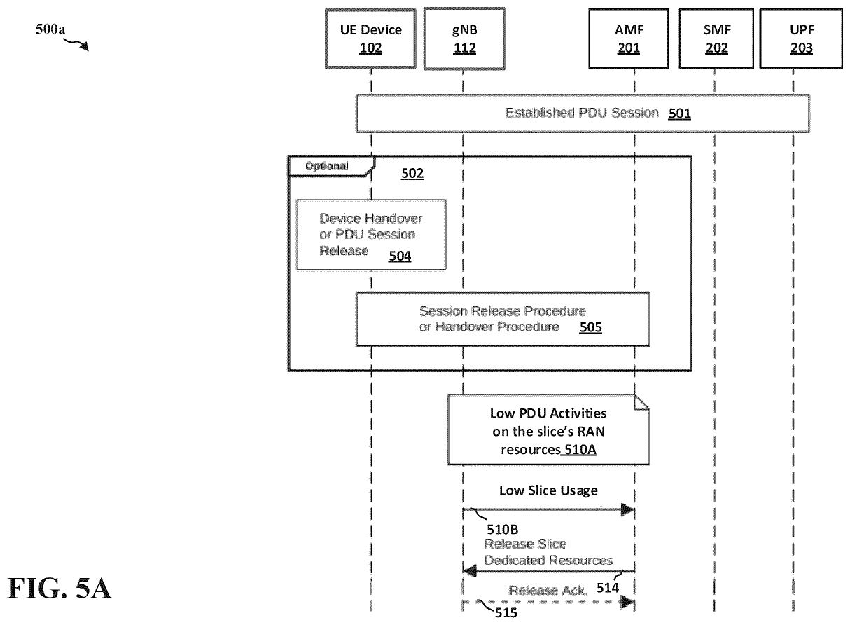

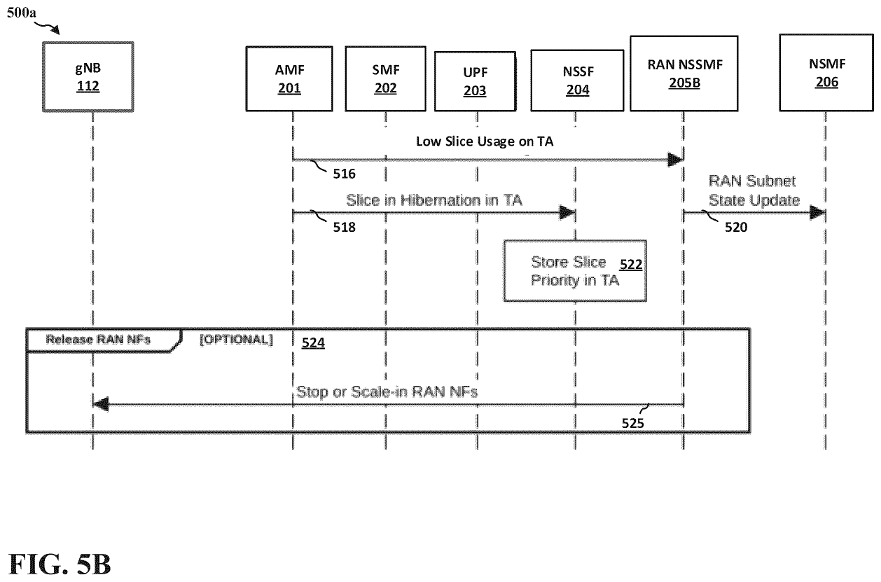

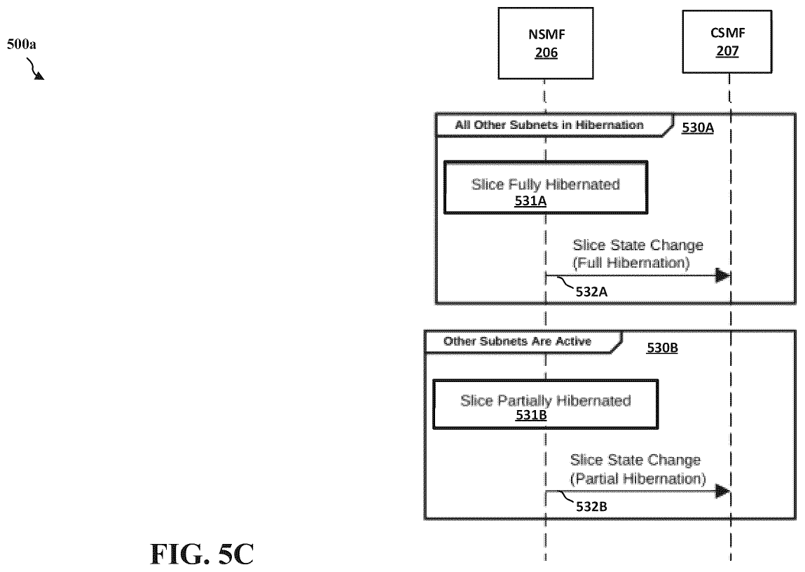

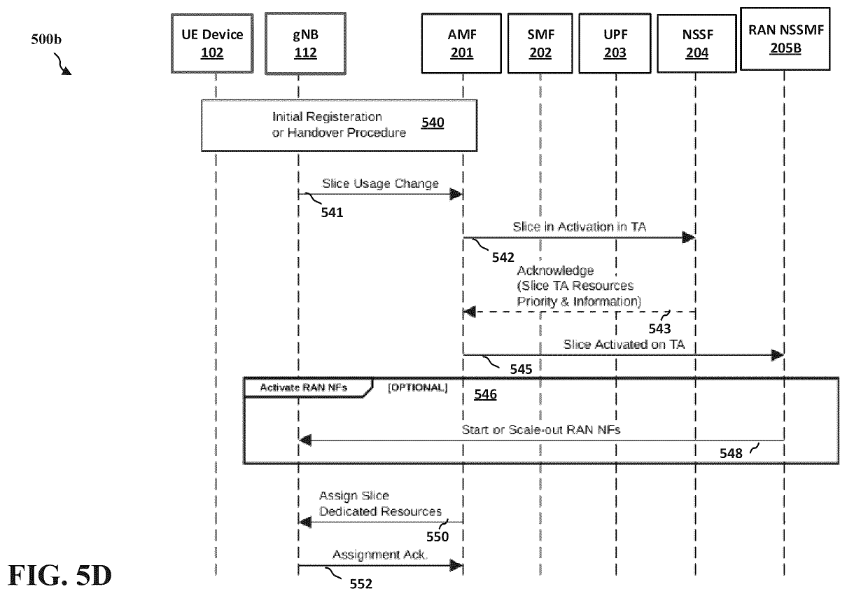

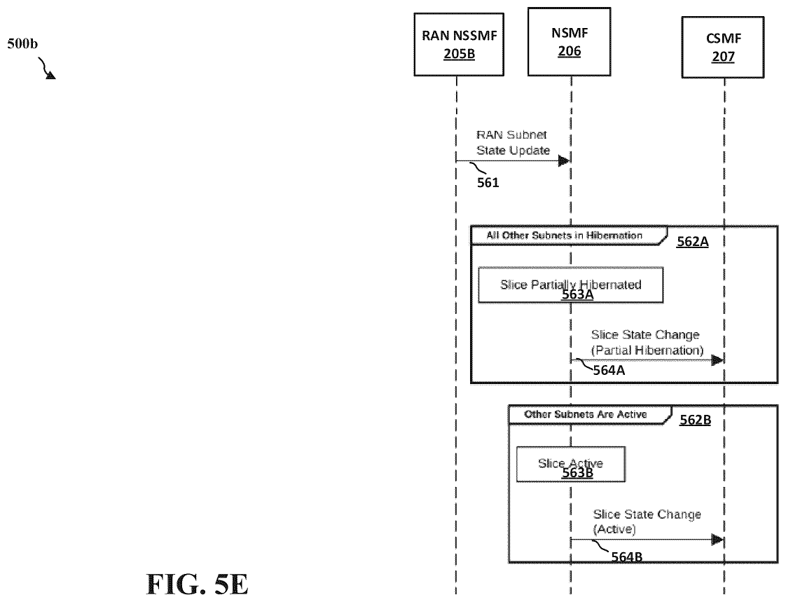

FIGS. 5A-5D are signaling diagrams illustrating an example process 500a of updating a RAN slice subnet state (e.g., 122), according to some embodiments. It is appreciated that the blocks in process 500a might be performed in an order different than presented, that not all of the blocks in process 500a might be performed, and the blocks might be combined with other processes presented herein.

As illustrated in FIGS. 5A-5C, the gNB 112 might detect no more slice resources are consumed in the tracking area and trigger AMF 201 to release all slice related resources on the radio network. For example, the AMF 201 might release all slice related resources on the RAN slice subnet 122. The AMF 201 might notify both the NSSMF and NSSF of such change. If all other slice subnets are already hibernated, the NSMF 206 might trigger the full hibernation state of the slice, otherwise the NSMF 206 might trigger the partial hibernation of the slice. The NSSMF 205 also might trigger releasing of resources assigned to RAN NF if the NF resources are not needed any more or were created for this specific slice. The CN transitions the state of the network slice 118 to be in the hibernation state based on the state of the RAN slice subnet 122. The details of the updating process will be discussed below.

The UE device 102 establishes a protocol data unit (PDU) session 501 similar to FIG. 4A session 401. The UE device 102, the base station 112, and the UPF 203 perform an optional PDU session release procedure 502. As part of the procedure, the UE device 102 determines 504 a device handover or a PDU session release. As an example, the UE device 102 might move to a different region or terminates its session. After all devices utilizing a specific slice are either in an idle mode, or moved to another gNB (handover), the gNB 112 might detect no more slice resources are consumed in this tracking area, or the slice resources consumed in this tracking area are below a first predetermined threshold. Then the UE device 102, the base station 112, and the UPF 203 start a PDU session procedure or a handover procedure 505.

At least one of the base station 112 or the AMF 201 receives a first trigger 510 on the slice to transition the slice from the operation state 303 to a hibernation state 311. As an example, at least one of the base station 112 or the AMF 201 might detect 510A the PDU session activities below a first predetermined PDU threshold on the RAN slice subnet. As an example, the base station 112 might send a first message 510B to the AMF 201 to indicate a usage of resources associated with the slice is below a first predetermined usage threshold. For example, the resources associated with the slice might include resources in terms of radio assignment, the QoS control, etc. For example, the resources associated with the slice might include the processing capabilities, the processing power, the memory, and/or the storage associated with the slice. This event might trigger the AMF 201 to release all slice related resources on the RAN. The AMF 201 might send a second message 514, to the base station 112, indicating to release slice dedicated resources associated with the slice. The base station 112 might send an acknowledgement 515 of receipt of the second message to the AMF 201.

The AMF 201 might also notify both the RAN NSSMF 205B and the NSSF 204. The AMF 201 might send a message 516, to the RAN NSSMF 205B, to indicate the usage of resources associated with the slice in a tracking area satisfying the first predetermined usage threshold. As an example, the AMF 201 might inform the RAN NSSMF 205B that there is no more slice usage in the specific tracking area. Then, the AMF 201 might send a message 518, to the NSSF 204, to indicate the RAN slice subnet associated with the tracking area in a hibernation state. As an example, the NSSF 204 might store 522 the priority of the service associated with the slice. The NSSF 204 might store the slice state in this tracking area (TA) in order to be able to restore the resources back according to the priority of the service associated with the slice. The RAN NSSMF 205B might update the state of the RAN slice subnet to be in a hibernation state and send a message 522 to the NSMF 206 to indicate the updating of the state of the RAN slice subnet.

The gNB 112 and the RAN NSSMF 205B might perform a RAN NFs release procedure 524. The RAN NSSMF 205B might send a message 525, to the gNB 112, indicating to release at least a portion of resources of RAN network functions (NFs) in the tracking area associated with the RAN slice subnet. If the resources of RAN NFs in the tracking area are only for the slice, all of the resources of RAN NFs in the tracking area might be released or stopped. If the resources of RAN NFs in the tracking area are shared with other slice(s), the resources of RAN NFs in the tracking area might be scaled down, with a portion of the resources of RAN NFs are released.

The NSMF 206 and the CSMF 207 perform a state transition procedure 530A or 530B to transition the state of the network slice to the full hibernated state 311A or the partial hibernated state 311B. In one example, the NSMF 206 and the CSMF 207 perform the state transition procedure 530A to transition the state of the network slice to the full hibernated state 311A. The NSMF 206 transitions 531A the state of the network slice to be in the full hibernation state 311A based on the state of the RAN slice subnet and each of all other slice subnets of the slice is in the hibernation state. The NSMF 206 might send a message532A to the CSMF 207 to indicate the state of the slice being in the full hibernation state based on the state of the RAN slice subnet and each of all other slice subnets of the slice is in the hibernation state. The CSMF 207 might store the information related to the hibernation of the slice. The NSMF 206 and the CSMF 207 perform a state transition procedure 530B to transition the state of the network slice to the partial hibernated state 311B. The NSMF 206 transitions 531B a state of the slice to be in the partial hibernation state based on the state of the RAN slice subnet and one or more other slice subnets of the slice are active. The NSMF 206 might send a message 532B to the CSMF 207 to indicate the state of the slice being in the partial hibernation state based on the state of the RAN slice subnet and one or more other slice subnets of the slice are active. For example, the CSMF 207 might store the information related to the hibernation of the slice.

By this way, the slice is now in the fully hibernated state 311A or the partially hibernated state 311B, and the NSSF 204 has transitioned the slice from the operation state 303 to the hibernation state 311A/311B based on the state change of the RAN slice subnet 122.

FIGS. 5D-5E are signaling diagrams illustrating an example process 500b of restoration a RAN slice subnet state (e.g., 122), according to some embodiments. It is appreciated that the blocks in process 500b might be performed in an order different than presented, that not all of the blocks in process 500b might be performed, and the blocks might be combined with other processes presented herein.

As illustrated in FIGS. 5D-5E, after the UE device 102 performs a handover procedure or initial registration 540 into the tracking area associated with the slice, the gNB 112 may notify the AMF 201 of the change of the usage of the slice resources. The AMF 201 might query the NSSF 204 for the priority information of the resources, and might report back to the gNB 112 for resources allocation, and might notify the NSSMF 205 for the state change of the slice. The NSSMF 205 might decide to scale/start RAN NF to accommodate the expected change. In case of fully utilized RAN resources, the gNB 112 might reply back to the AMF 201 with a rejection message for the slice dedicated resources assignment message. The rejection message might indicate not enough resources, and the AMF 201 might define a retry timer based on one of the following options: randomly generated, predicted usage increase for the slice (relying on NWDAF for trend analysis), or slice restoration requests within a specific time frame. The retry timer might then be propagated by gNB 112 towards the UE device 102 to prevent signaling storms. The details of the restoration process will be discussed below.

The UE device 102 performs a handover procedure or initial registration 540 into the tracking area associated with the slice. The UE device 102 might come back or do a handover. The UE device 102 might come back to the area and reconnect to try to access the slice. The gNB 112 might detect, the usage of resources associated with the slice above a second predetermined threshold. The base station 112 might send a message 541 to the AMF 201 of the core network to indicate the usage of resources associated with the slice above the second predetermined threshold. As an example, the gNB112 might notify the AMF 201 of the change of the usage of the slice resources.

The AMF 201 might inform 542 the NSSF 204 that the slice is in activation in the tracking area. As an example, the AMF 201 might query the NSSF 204 for the priority information of the resources. The NSSF 204 might send an acknowledgement 543 to the AMF 201 with information about the priority of the service associate with the slice in the tracking area. The AMF 201 might inform the RAN NSSMF 205B that the slice is activated in the tracking area. As an example, the AMF 201 might notify the NSSMF 205 for the state change of the slice.

The gNB 112 and the RAN NSSMF 205B might perform a RAN NFs activation procedure 546. The RAN NSSMF 205B might send a message 548 to the base station 112 indicating to restore the at least a portion of the resources of RAN NFs in the tracking area associated with the RAN slice subnet. For example, the NSSMF 205 might decide to scale/start RAN NF to accommodate the expected state change of the RAN slice subnet 122. The AMF 201 might send a message 550 to the base station 112 to assign the slice dedicated resources to the RAN slice subnet. The base station 112 might send an acknowledgement 552 of receipt of the assignment to the AMF 201.

The RAN NSSMF 205B might update 561 the state of the RAN slice subnet to be in an active state and inform the NSMF 206 the updating of the state of the RAN slice subnet. In one example, the NSMF 206 and the CSMF 207 perform the state transition procedure 562A to transition the state of the network slice. The NSMF 206 transitions 563A the state of the slice to be in the partial hibernation state 311B based on the state of the RAN slice subnet and other one or more slice subnets of the slice are in the hibernation state. The NSMF 206 might inform 564A the CSMF 207 the state of the slice being in the partial hibernation state 311B based on the state of the RAN slice subnet and other slice subnets of the slice are in the hibernation state. in another example, the NSMF 206 and the CSMF 207 perform the state transition procedure 562B to transition the state of the network slice according to operations 563B and 564B. The NSMF 206 transitions 563B the state of the slice to be in the operation state 303 the based on the state of the RAN slice subnet and all other slice subnets of the slice are active. The NSMF 206 might informs 564B the CSMF 207 the state of the slice being in the operation state 303 based on the state of the RAN slice subnet and all other slice subnets of the slice are active. For example, the CSMF 207 might store the information related to the hibernation of the slice.

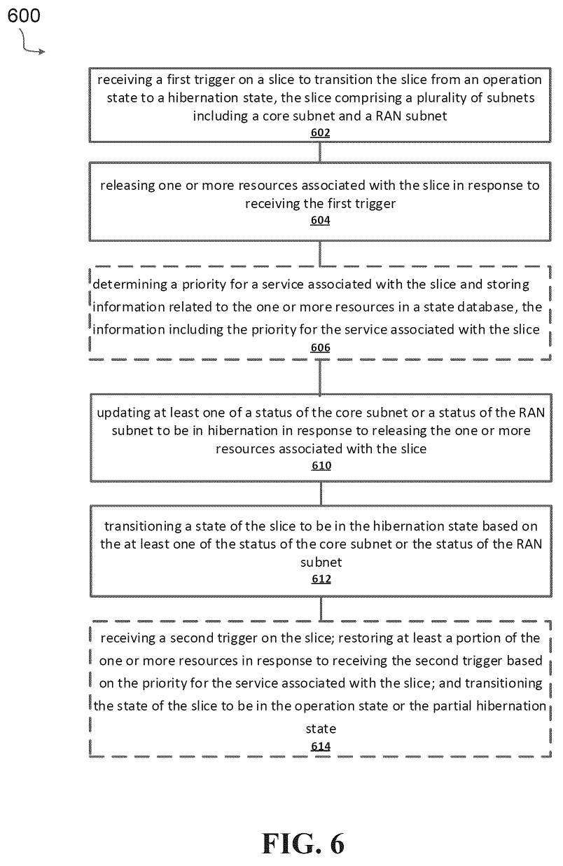

FIG. 6 is a flow diagram illustrating a method of introducing a hibernation state within a life-cycle of a network slice, according to some embodiments. The method 600 is performed by a CN, such as the CN 110. As described with connection to FIGS. 4A-4F and FIGS. 5A-5E, the CN transitions the state of the network slice 118 to be in the hibernation state (e.g., 311A or 311B) based on the state of the CN slice subnet 121 or the state of the RAN slice subnet 122.

As shown in FIG. 6, the method 600 includes the AMF of a CN receiving 602 a first trigger including the network slice information for the service requested to transition the network slice from an operation state 303 to a hibernation state 311. Examples of this first trigger include a PDU session release 402 initiated by a UE or low PDU activity on the network slice at the CN 410. The network slice traverses a plurality of slice subnets including a CN slice subnet and a RAN slice subnet. The method 600 includes the CN releasing 604 one or more slice subnet resources associated with the network slice in response to receiving the first trigger.

For example, the hibernation state 311 might include a full hibernation state 311A in which each of the plurality of slice subnets of the slice is in a hibernation state, or a partial hibernation state 311B in which a portion of the plurality of slice subnets of the slice is in a hibernation state.

The method 600 might include the NSSF of the CN determining 606 a priority for a service associated with the slice and storing information related to the one or more resources in a state database. The information includes the priority for the service associated with the slice.

The method 600 includes the CN updating 610 at least one of a state of the CN slice subnet (e.g., 425) or a state of the RAN slice subnet (e.g., 520) to be in a hibernation state in response to releasing the one or more resources. The method 600 includes the CN transitioning 612 a state of the slice to be in the hibernation state based on the at least one of the state of the CN slice subnet (e.g., 430A, 430B) or the state of the RAN slice subnet (e.g., 530A, 530B).

The method 600 might include the CN receiving 614 a second trigger (e.g., 444) on the slice; restoring at least a portion of the one or more resources in response to receiving the second trigger based on the priority for the service associated with the slice (e.g., 450A, 450B); and transitioning the state of the slice to be in the operation state 303 or the partial hibernation state 311B (e.g., 462A, 462B).

By this method, the CN releases a network resource associated with the network slice in response to receiving the first trigger, and transitions the state of the network slice 118 to be in the hibernation state (e.g., 311A or 311B) based on the state of the CN slice subnet 121 or the state of the RAN slice subnet 122.

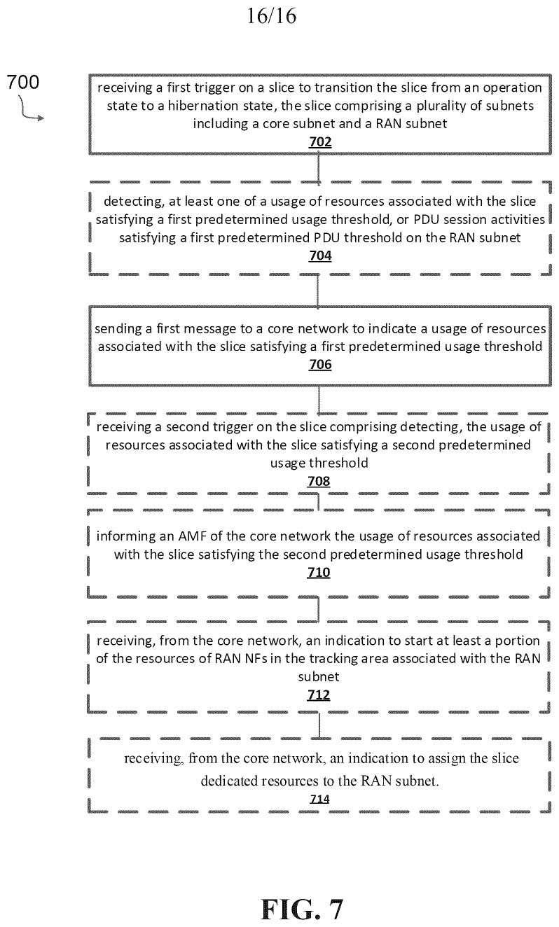

FIG. 7 is a flow diagram illustrating a method 700 of introducing a hibernation state within a life-cycle of a network slice, according to some embodiments. The method 700 is performed by a base station, such as the gNB 112. The base station sends a first message to a CN to indicate a usage of resources associated with the network slice satisfying a first predetermined usage threshold, then, the CN transitions a state of the network slice to be in the hibernation state (311A or 311B)) based on the state of the RAN slice subnet.

As shown in FIG. 7, the method 700 includes the base station receiving 702 a first trigger on a slice to transition the slice from an operation state to a hibernation state. Examples of this first trigger include a session release or handover procedure 505, or low PDU activity on the network slice's RAN resources 510A. The slice includes a plurality of slice subnets including a CN slice subnet and a RAN slice subnet. The method 700 might include the base station detecting 704, at least one of a usage of resources associated with the slice satisfying a first predetermined usage threshold, or PDU session activities satisfying a first predetermined PDU threshold on the RAN slice subnet (e.g., 510A).

The method 700 includes the base station sending 706 a message (e.g., 510B) to a core network to indicate a usage of resources associated with the slice satisfying a first predetermined usage threshold.

The method 700 might include the base station receiving 708 a second trigger on the slice, for example, detecting, the usage of resources associated with the slice satisfying a second predetermined usage threshold. The method 700 might include the base station informing 710 an AMF of the core network the usage of resources associated with the slice satisfying the second predetermined usage threshold (e.g., 541).

The method 700 might include the base station receiving 712, from the core network, a message (e.g., 548) to start at least a portion of the resources of RAN NFs in the tracking area associated with the RAN slice subnet. The method 700 might include the base station receiving 714, from the core network, a message (e.g., 550) to assign the slice dedicated resources to the RAN slice subnet.

By this method, the base station receives a first trigger on a network slice to transition the network slice from the operation state 303 to the hibernation state (311A or 311B), and sends a message to a core network to indicate a usage of resources associated with the network slice satisfying a first predetermined usage threshold. Therefore, a network resource associated with the network slice is released, a state of the RAN slice subnet is updated to be in a hibernation state, and the state of the network slice is transitioned to be in the hibernation state (311A or 311B) based on the state of the RAN slice subnet.

The technical solutions presented herein introduces the hibernation state 311A or 311B within the life-cycle of a network slice. The hibernation state modifies the network slice during the operation state in order to release underutilized resources. The hibernation state includes a full hibernation state and a partial hibernation state. In the full hibernation state, the network slice resources are fully in hibernation across all the slice subnets (CN, RAN, and transmission) to release underutilized resources. In the partial hibernation state, only a set of resources are in hibernation (e.g. radio resources in certain regions only, specific transmission links) while other resources of the network slice remain assigned to the original service. After any of the hibernated resources is requested by the original service associated with the network slice, if all resources are active, the CN transitions the state of the network slice to the operation state; or if a portion of the resources is still in hibernation, the CN transitions the state of the network slice to the partial hibernation state. the CN performs the restoration of the resources based on the priority stored in the state database.

By the technical solutions discussed above, the CN advantageously allocate the valuable network resources efficiently to meet the increasing services demands. The technical solutions operational improve the efficiency of the network operator for non-slice or lower-priority network slicing services. In addition, other services are able to run smoothly by using the resources that would otherwise be reserved for the original service and temporarily unused.

Unless specifically stated otherwise, terms such as “receiving,” “releasing,” “updating,” “transitioning,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and might not necessarily have an ordinal meaning according to their numerical designation.

Examples described herein also relate to an apparatus for performing the operations described herein. This apparatus might be specially constructed for the required purposes, or it might include a general purpose computing device selectively programmed by a computer program stored in the computing device. Such a computer program might be stored in a computer-readable non-transitory storage medium.

The methods and illustrative examples described herein are not inherently related to any particular computer or other apparatus. Various general purpose systems might be used in accordance with the teachings described herein, or it might prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

Method 600 and method 700 are performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

Method 600 and method 700 illustrate example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 might be performed in an order different than presented, and that not all of the blocks in method 600 might be performed.

It should also be noted that in some alternative implementations, the functions/acts noted might occur out of the order noted in the figures. For example, two figures shown in succession might in fact be executed substantially concurrently or might sometimes be executed in the reverse order, depending upon the functionality/acts involved.

Although the method operations were described in a specific order, other operations might be performed in between described operations, described operations might be adjusted so that they occur at slightly different times or the described operations might be distributed in a system which allows the occurrence of the processing operations at various intervals associated with the processing.

These apparatus and methods are illustrated in the accompanying drawings by various blocks, components, circuits, processes, algorithms, etc. (collectively referred to as “elements”). These elements might be implemented using electronic hardware, computer software, or any combination thereof.

For example, an element, or any portion of an element, or any combination of elements might be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

The functions described might be implemented in hardware, software, or any combination thereof. If implemented in software, the functions might be stored on or encoded as one or more instructions or code on a computer-readable medium. Computer-readable media includes computer storage media. Storage media might be any available media that can be accessed by a computer. For example, such computer-readable media might comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various units, circuits, or other components might be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” might also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as might be suited to the particular use contemplated. Accordingly, the present embodiments are to be considered as illustrative and not restrictive, and the present disclosure is not to be limited to the details given herein, but might be modified within the scope and equivalents of the appended claims.

1-15. (canceled)

16. A method, comprising:
receiving, by a core network (CN), a first trigger for a network slice to transition from an operation state to a hibernation state, the network slice comprising a first slice subnet and a second slice subnet;
releasing a first resource associated with the first slice subnet while maintaining a second resource associated with the second slice subnet; and
causing the network slice to transition to the hibernation state.

17. The method of claim 16, wherein the hibernation state is a partial hibernation state in which:
the first slice subnet is inactive, and
the second slice subnet is active.

18. The method of claim 16,
wherein receiving the first trigger comprises at least one of:
detecting, by an access and mobility management function (AMF), that activities of a protocol data unit (PDU) session between the CN and a user device are below a first activities threshold; or
receiving, from a base station, an indication that the activities of the PDU session are below the first activities threshold.

19. The method of claim 16, wherein the first slice subnet is a CN slice subnet, the method further comprising:
establishing, based on the first trigger, a PDU session modification procedure between the AMF and a user plane function (UPF) of the CN.

20. The method of claim 19, further comprising:
sending, from a session management function (SMF) of the CN to a network slice selection function (NSSF) of the CN, a request to release the first resource of the UPF; and
receiving, by the SMF from the NSSF, an acknowledgement of the request to release the first resource of the UPF, wherein the acknowledgement comprises an indication of whether the UPF is a dedicated slice UPF or a shared slice UPF.

21. The method of claim 20, wherein the acknowledgement indicates that the UPF is a dedicated slice UPF, and wherein releasing the first resource comprises:
releasing, by a network slice subnet management function (NSSMF) of the CN, all resources of the UPF.

22. The method of claim 20, wherein the acknowledgement indicates that the UPF is a shared UPF, and wherein releasing the first resource comprises:
releasing, by a network slice subnet management function (NSSMF) of the CN, a portion of all resources of the UPF.

23. The method of claim 16, wherein the first slice subnet is a radio access network (RAN) slice subnet, the method further comprising:
sending, from the AMF, to a network slice subnet management function (NSSMF) of a RAN, an indication that usage of the first resource in a tracking area satisfies a first usage threshold, wherein the RAN slice subset is associated with the tracking area; and
sending, from the AMF to a network slice selection function (NSSF) of the CN, an indication to cause the RAN slice subset to transition to the hibernation state.

24. The method of claim 23, further comprising:
sending, from the AMF to a base station, an indication of release of the first resource; and
receiving, by the AMF and from the base station, an acknowledgement of the indication of release of the first resource.

25. The method of claim 16, further comprising:
sending, from a NSSMF to a network slice management function (NSMF), a state update of the first slice subnet.

26. The method of claim 16, further comprising:
determining a priority for a service associated with the network slice; and
storing the priority for the service at the NSSF.

27. The method of claim 16, further comprising:
receiving, by the CN, a second trigger; and
restoring the first resource.

28. The method of claim 27, wherein restoring the first resource is based on a priority of a service associated with the network slice.

29. The method of claim 17,
wherein receiving the first trigger comprises at least one of:
detecting, by an access and mobility management function (AMF), that activities of a protocol data unit (PDU) session between the CN and a user device are below a first activities threshold; or
receiving, from a base station, an indication that the activities of the PDU session are below the first activities threshold.

30. The method of claim 17, wherein the first slice subnet is a CN slice subnet, the method further comprising:
establishing, based on the first trigger, a PDU session modification procedure between the AMF and a user plane function (UPF) of the CN.

31. The method of claim 18, wherein the first slice subnet is a CN slice subnet, the method further comprising:
establishing, based on the first trigger, a PDU session modification procedure between the AMF and a user plane function (UPF) of the CN.

32. The method of claim 17, wherein the first slice subnet is a radio access network (RAN) slice subnet, the method further comprising:
sending, from the AMF to a network slice subnet management function (NSSMF) of a RAN, an indication that usage of the first resource in a tracking area satisfies a first usage threshold, wherein the RAN slice subset is associated with the tracking area; and
sending, from the AMF to a network slice selection function (NSSF) of the CN, an indication to cause the RAN slice subset to transition to the hibernation state.

33. The method of claim 18, wherein the first slice subnet is a radio access network (RAN) slice subnet, the method further comprising:
sending, from the AMF to a network slice subnet management function (NSSMF) of a RAN, an indication that usage of the first resource in a tracking area satisfies a first usage threshold, wherein the RAN slice subset is associated with the tracking area; and
sending, from the AMF to a network slice selection function (NSSF) of the CN, an indication to cause the RAN slice subset to transition to the hibernation state.

34. A non-transitory computer-readable storage medium including instructions that, when executed by a processor, cause the processor to:
receive, at a core network (CN), a first trigger for a network slice to transition from an operation state to a hibernation state, the network slice comprising a first slice subnet and a second slice subnet;
release a first resource associated with the first slice subnet while maintaining a second resource associated with the second slice subnet; and
cause the network slice to transition to the hibernation state.

35. An apparatus comprising:
a memory storing instructions; and
a processor coupled to the memory,
wherein the processor is configured to execute the instructions to:
receive, at a core network (CN), a first trigger for a network slice to transition from an operation state to a hibernation state, the network slice comprising a first slice subnet and a second slice subnet;
release a first resource associated with the first slice subnet while maintaining a second resource associated with the second slice subnet; and
cause the network slice to transition to the hibernation state.
